(19) United States
(12) Patent Application Publication
(10) Pub. No.: US 2013/0152619 A1
(43) Pub. Date: Jun. 20, 2013

(54) AIR CONDITIONING APPARATUS FOR VEHICLE

(71) Applicant: KEIHIN CORPORATION, Tokyo (JP)

(72) Inventor: Yoshiomi ITO, Kuki-shi (JP)

(73) Assignee: KEIHIN CORPORATION, Tokyo (JP)

(21) Appl. No.: 13/712,012

(22) Filed: Dec. 12, 2012

(30) Foreign Application Priority Data
Dec. 16, 2011 (JP) 2011-275739

(51) Int. Cl. B60H 1/00

(52) U.S. Cl. CPC B60H 1/00028
USPC 62/408

(57) ABSTRACT

An air conditioning apparatus for a vehicle that includes a frame having an opening through which an airflow passes, and a sliding door which adjusts an aperture ratio of the opening by being slid along a wall surface formed with the opening of the frame in an upstream side of the opening, wherein the sliding door includes: a shield plate to shield the airflow; and a seal member which extends from the shield plate in a sliding direction of the sliding door and is more easily bent than the shield plate, and which is bent by receiving the airflow, thereby coming into contact with the wall surface of the frame.

Priority is claimed on Japanese Patent Application No. 2011-275739, filed Dec. 16, 2011, the disclosure of which is hereby incorporated herein by reference in its entirety.

### BACKGROUND

1. Field of the Invention

The present invention relates to an air conditioning apparatus for a vehicle.

2. Description of Related Art

An air conditioning apparatus for a vehicle is to supply conditioned air of which a temperature or the like is regulated into a vehicle interior. The air conditioning apparatus for a vehicle includes a case having an air passage therein, and a heater core or an evaporator disposed in the middle of the air passage. Such an air conditioning apparatus for a vehicle regulates a temperature or humidity of air supplied from the outside with the heater core or the evaporator and supplies the regulated air as the conditioned air into the vehicle interior.

The air conditioning apparatus for a vehicle generally includes a frame which is integral with the case. The frame is formed with a plurality of openings disposed in the middle of the air passage. That is, air flows through the openings provided in the frame. For example, the frame is provided with a heating opening to supply the air cooled by the evaporator to the heater core, or a cold air opening to bypass the heater core. In such an air conditioning apparatus for a vehicle, a ratio of the air, which passes through the heating opening and the cold air opening, is adjusted, and thereby the temperature of the conditioned air is regulated.

The ratio of the air passing through the heating opening and the cold air opening is adjusted by moving a sliding door which changes an aperture ratio of the heating opening and the cold air opening arranged adjacent to each other.

A slight gap occurs between the sliding door and a wall surface formed with the openings of the frame. If such a gap occurs, a slight air leakage is generated from the gap even in a state of completely closing the openings with the sliding door.

In order to prevent such an air leakage, full-depth teeth are provided with respect to a pinion to slide the sliding door, and the full-depth teeth allow the generation of the gap to be suppressed by pressing the sliding door against the wall surface of the frame in a position where the sliding door closes the openings, as disclosed in, for example, Japanese Unexamined Patent Application, First Publication No. H10-278544.

### SUMMARY

In a case of providing the full-depth teeth with respect to the pinion, however, the pinion has a complicated shape. In addition, the full-depth teeth need to be in contact with the sliding door when the sliding door is in a position of closing the openings, whereas the full-depth teeth need not to be in contact with the sliding door in the middle of movement. For this reason, the size of the pinion or the position of each full-depth tooth is restricted, and further there is a need to perform work while considering the rotation angle of the pinion during the assembly of the air conditioning apparatus for a vehicle.

Aspects according to the present invention has been made in view of the above-mentioned problems, and an object thereof is to be capable of preventing an air leakage without causing a complicated structure of a pinion and deterioration in working properties during assembly, in an air conditioning apparatus for a vehicle.

Aspects according to the present invention adopt the following configurations as means for solving the above-mentioned problems.

(1) In accordance with an aspect of the present invention, an air conditioning apparatus for a vehicle includes a frame having an opening through which an airflow passes, and a sliding door which adjusts an aperture ratio of the opening by being slid along a wall surface formed with the opening of the frame in an upstream side of the opening, wherein the sliding door includes a shield plate to shield the airflow; and a seal member which extends from the shield plate in a sliding direction of the sliding door and is more easily bent than the shield plate, and which is bent by receiving the airflow, thereby coming into contact with the wall surface of the frame.
(2) In the aspect as (1) described above, the seal member may have restoration properties.
(3) In the aspect as (1) or (2) described above, the frame may include a seal surface which is disposed adjacent to the opening and comes into contact with the seal member, and a guide which guides the sliding door and approaches the seal surface as moving away from the opening.
(4) In any one of the aspects as (1) to (3) described above, the seal member may be inclined in a downstream side of the airflow.
(5) In the aspect as (3) or (4) described above, the guide may be curved so that a central portion of the sliding door in the sliding direction thereof swells toward the downstream side of the airflow.
(6) In any one of the aspects as (1) to (5) described above, the seal member may include a fore-end portion which has a contact surface with the frame, the contact surface being a curved surface, a base portion connected with the shield plate, and a neck portion which is connected with the fore-end portion and the base portion and is thinner than the base portion.
(7) In the aspect as (6) described above, a position of the seal member may be set so that an angle between an axis, which penetrates centers of the base portion, the neck portion, and the fore-end portion, and the wall surface of the frame, which comes into contact with the seal member, in the upstream side of the airflow is larger than 90° and less than 180°.

In accordance with the aspect according to the present invention, a seal member is bent by receiving an airflow, thereby coming into contact with a wall surface formed with an opening of a frame. When a sliding door completely closes the opening, the seal member comes into contact with the wall surface formed with the opening of the frame, thereby preventing a gap from being generated between the sliding door and the frame.

Moreover, in accordance with the aspect according to the present invention, the gap may be easily prevented from being generated between the sliding door and the frame without providing full-depth teeth on a pinion to slide the sliding door. Accordingly, in an air conditioning apparatus for a vehicle, an air leakage may be prevented without causing a complicated structure of the pinion and deterioration in working properties during assembly.

### BRIEF DESCRIPTION OF THE DRAWINGS

FIG. 1 is a longitudinal cross-sectional view illustrating a schematic configuration of an air conditioning apparatus for a vehicle according to an embodiment of the present invention.

FIG. 2A is a perspective view when viewing the inner surface side of a sliding door provided in the air conditioning apparatus for a vehicle.

FIG. 2B is a perspective view when viewing the outer surface side of the sliding door,

FIG. 2C is a side view of the sliding door.

FIG. 3A is an enlarged schematic view illustrating the vicinity of an upper side seal surface provided in the air conditioning apparatus for a vehicle.

FIG. 3B is an enlarged schematic view illustrating the vicinity of a lower side seal surface provided in the air conditioning apparatus for a vehicle.

FIG. 4A is a schematic view illustrating a shield plate, a seal member, and a seal surface.

FIG. 4B is a schematic view illustrating the shield plate, the seal member, and the seal surface.

FIG. 4C is a schematic view illustrating the shield plate, the seal member, and the seal surface.

### DESCRIPTION OF THE EMBODIMENTS

Hereinafter, an air conditioning apparatus for a vehicle of an embodiment according to the present invention will be described with reference to the accompanying drawings. Also, the scale of each member is appropriately modified in order to make a recognizable size of the member in the drawings described below.

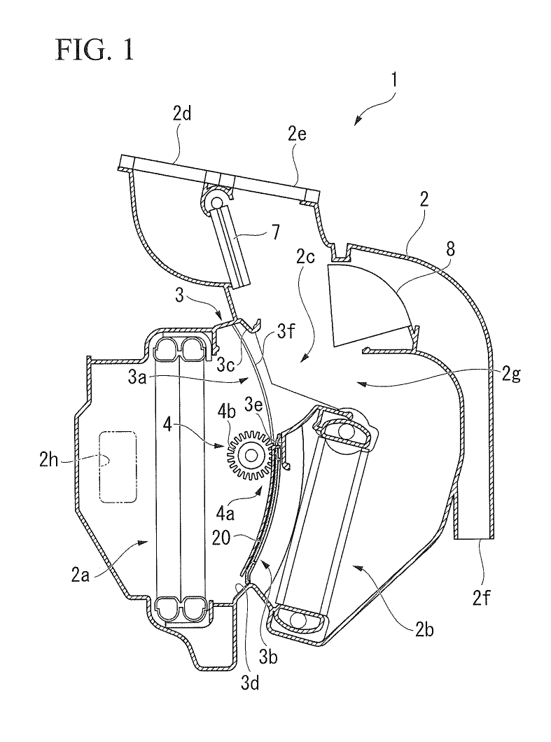

FIG. 1 is a longitudinal cross-sectional view illustrating a schematic configuration of an air conditioning apparatus for a vehicle 1, for the purpose of HVAC (Heating, Ventilation, and Air Conditioning), according to an embodiment of the present invention. As shown in this drawing, the air conditioning apparatus for a vehicle 1 includes a case 2, a frame 3, an air mix damper device 4, an evaporator 5, a heater core 6, a mode switching damper 7, and a foot outlet mode damper 8.

The case 2 defines an external shape of the air conditioning apparatus for a vehicle 1 according to the present embodiment. The case 2 includes therein a cooling passage 2a installed with the evaporator 5, a heating passage 2b installed with the heater core 6, and a mixing portion 2c which generates conditioned air by mixing cold air (airflow) and warm air (airflow). In addition, the case 2 is provided with a plurality of outlets (a defroster outlet 2d, a face outlet 2e, and a foot outlet 20 which is exposed to the outside and connected with the mixing portion 2c.

The defroster outlet 2d is an opening to supply the conditioned air with respect to a window.

In addition, the face outlet 2e is an opening to supply the conditioned air with respect to the face of a passenger.

In addition, the foot outlet 2f is an opening to supply the conditioned air with respect to the feet of a passenger.

Furthermore, the case 2 includes therein a warm air opening 2g which supplies the warm air from the heating passage 2b installed with the heater core 6 to the mixing portion 2c.

The case 2 includes an opening 2h provided in the upstream side of the evaporator 5, and air is sent from the opening 2h into the case 2 by an air blower (not shown).

The frame 3 includes a cold air opening 3a which supplies the cold air from the cooling passage 2a installed with the evaporator 5 to the mixing portion 2c, and a heating opening 3b which supplies the cold air form the cooling passage 2a to the heating passage 2b. The frame 3 is integral with the case 2 and is provided within the case 2.

In addition, the frame 3 has an upper side seal surface 3c (wall surface) which comes into contact with a sliding door 20 when the sliding door 20 closes the cold air opening 3a, and a lower side seal surface 3d (wall surface) which comes into contact with the sliding door 20 when the sliding door 20 closes the heating opening 3b. In addition, the frame 3 has an intermediate seal surface 3e (wall surface), which is disposed between the cold air opening 3a and the heating opening 3b, comes into contact with an edge portion (a lower side seal member 23b to be described later) of the lower side of the sliding door 20 when the sliding door 20 closes the cold air opening 3a, and comes into contact with an edge portion (an upper side seal member 23a to be described later) of the upper side of the sliding door 20 when the sliding door 20 closes the heating opening 3b. In the description below, the upper side seal surface 3c, the lower side seal surface 3d, and the intermediate seal surface 3e as a generic term are referred to as a seal surface 3x.

In more detail, in the present embodiment, the cold air opening 3a is provided upward and the heating opening 3b is provided downward, as shown in FIG. 1. A portion of a wall surface of the frame 3, which is located upward of the cold air opening 3a, is the upper side seal surface 3c, and the upper side seal surface 3c comes into contact with the edge portion (the upper side seal member 23a to be described later) of the upper side of the sliding door 20 when the sliding door 20 closes the cold air opening 3a. In addition, a portion of the wall surface of the frame 3, which is located downward of the heating opening 3b, is the lower side seal surface 3d, and the lower side seal surface 3d comes into contact with the edge portion (the lower side seal member 23b to be described later) of the lower side of the sliding door 20 when the sliding door 20 closes the heating opening 3b.

In addition, the frame 3 has guide rails (guides) 3f to guide the sliding door 20 at sides of the frame 3. The guide rails 3f are provided at the opposite sides of the frame 3 with interposing the sliding door 20 therebetween. As shown in FIG. 1, each of the guide rails 3f is curved along a predetermined arc so that a center of the guide rail 3f in a height direction thereof is recessed at the evaporator 5 side and swells at the heater core 6 side. That is, the guide rail 3f in the present embodiment is curved so that a central portion of the sliding door 20 in a sliding direction thereof swells toward the downstream side of the airflow.

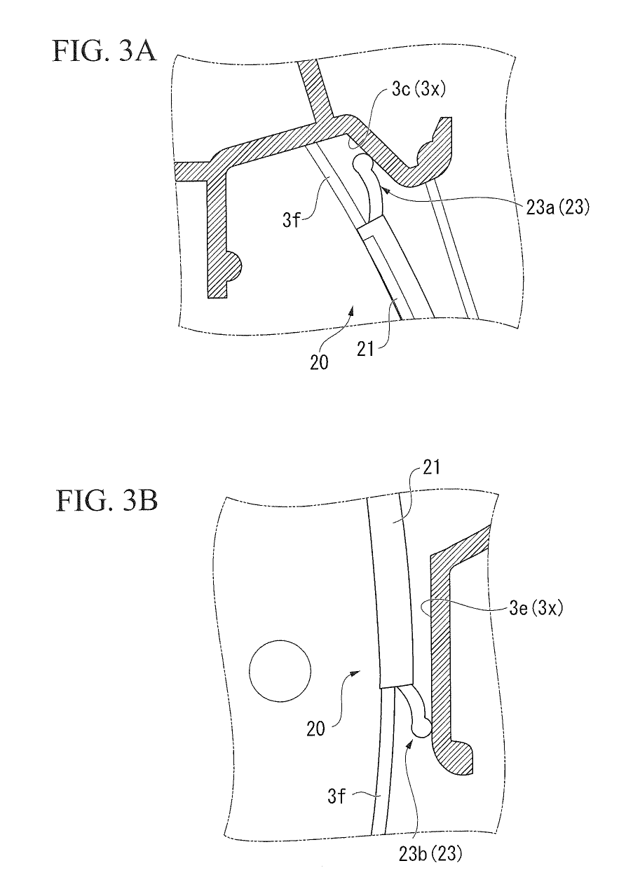

In the present embodiment, the guide rail 3f approaches the upper side seal surface 3c as moving away from the cold air opening 3a (see FIG. 3A to be described later). In addition, the guide rail 3f approaches the lower side seal surface 3d as moving away from the heating opening 3b.

The air mix damper device 4 is disposed in the downstream side of the evaporator 5 and is to adjust a supply amount of the cold air, which is generated by the evaporator 5, to the heating passage 2b. In more detail, the air mix damper device 4 includes the sliding door 20 which is slidable between the cold air opening 3a and the heating opening 3b, and rack and pinion mechanisms 4a to drive the sliding door 20.

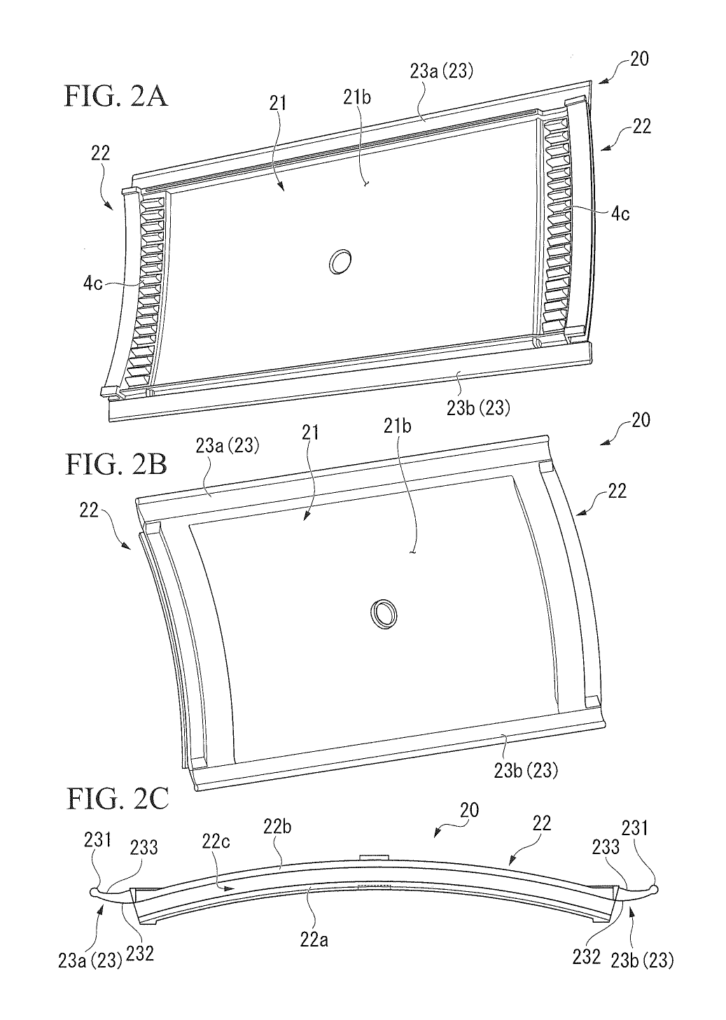

FIG. 2A is a perspective view when viewing the inner surface side of the sliding door 20. FIG. 2B is a perspective view when viewing the outer surface side of the sliding door 20. FIG. 2C is a side view of the sliding door 20.

As shown in this drawing, the sliding door 20 includes a shield plate 21, guide portions 22, and a seal member 23.

The shield plate 21 is a curved plate made of a resin material. The shield plate 21 has an inner surface 21a which is curved along the inner side of a predetermined arc, and an outer surface 21b which is curved along the outer side of a predetermined arc. The inner surface 21a and the outer surface 21b are curved in parallel with each other because being curved along the inner side and the outer side of the same arc. Furthermore, the inner surface 21a is directed to the evaporator 5 side and the outer surface 21b is directed to the heater core 6 side.

The guide portions 22 are provided at opposite sides of the shield plate 21, and each of the guide portions 22 is a part which is connected to the guide rail 3f provided at the frame 3. The guide portion 22 includes a first rib 22a which is curved and formed at the inner surface 21a side of the shield plate 21, a second rib 22b which is curved and formed at the outer surface 21b side of the shield plate 21, and a guide groove 22c formed by the first rib 22a and the second rib 22b. In addition, the first rib 22a and the second rib 22b are curved so that the guide groove 22c and the guide rail 3f have the same curvature. Such a guide portion 22 is connected to be slidable with respect to the guide rail 3f by fitting the guide groove 22c to the guide rail 3f. In addition, the shield plate 21 is supported to be slidable with respect to the frame 3 by the guide portion 22.

As shown in FIG. 2C, the seal member 23 is a part which extends outward from opposite ends of the shield plate 21 in the sliding direction of the sliding door 20. The seal member 23 comes into contact with the upper side seal surface 3c of the frame 3 having the cold air opening 3a and the heating opening 3b, the lower side seal surface 3d, or the intermediate seal surface 3e. The seal member 23 is formed throughout a region from one side of the shield plate 21 to the other side thereof. Furthermore, when the sliding door 20 completely closes the cold air opening 3a, the seal member 23 located at the upper side (hereinafter, referred to as the upper side seal member 23a) comes into contact with the upper side seal surface 3c as shown in the schematic view of FIG. 3A. In addition, the seal member 23 located at the lower side (hereinafter, referred to as the lower side seal member 23b) comes into contact with the intermediate seal surface 3e as shown in the schematic view of FIG. 3B.

In addition, when the sliding door 20 completely closes the heating opening 3b, the upper side seal member 23a comes into contact with the intermediate seal surface 3e and the lower side seal member 23b comes into contact with the lower side seal surface 3d.

In addition, the seal member 23 in the present embodiment is more easily bent than the shield plate 21 and is bent by receiving the airflow. Furthermore, the seal member 23 is more easily bent than the shield plate 21 by being made of a more flexible material than the shield plate 21 or being formed to be thinner than the shield plate 21.

In addition, the seal member 23 in the present embodiment has restoration properties by being made of an elastic material or the like. Therefore, the seal member 23 attempts to be restored to an original shape even when the seal member 23 is bent by applying an external force to the seal member 23, and the seal member 23 is restored to an original shape when an external force is not applied with respect to the seal member 23.

As shown in FIG. 2C, the seal member 23 is constituted of a fore-end portion 231 which has a contact surface with the seal surface (the upper side seal surface 3c, the lower side seal surface 3d, and the intermediate seal surface 3e), the contact surface being a curved surface, a base portion 232 connected with the shield plate 21, and a neck portion 233 which is connected with the fore-end portion 231 and the base portion 232 and is thinner than the base portion 232.

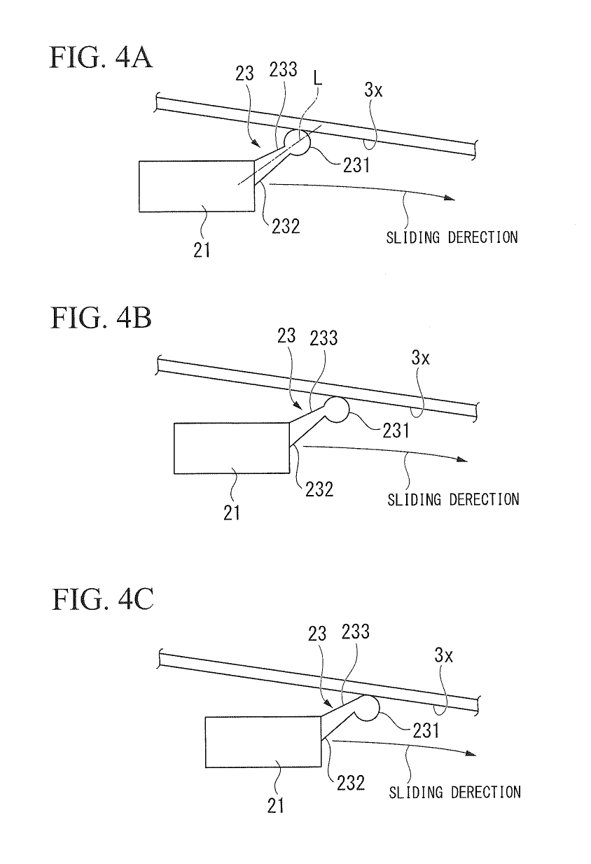

FIGS. 4A to 4C are schematic views illustrating the shield plate 21, the seal member 23, and the seal surface 3x (the upper side seal surface 3c, the lower side seal surface 3d, and the intermediate seal surface 3e) and show a state in which the seal member 23 moves in turn. As shown in FIG. 4A, a position of the seal member 23 with respect to the shield plate 21 is set so that an angle θ between the seal surface 3x and an axis L, which penetrates centers of the base portion 232, the neck portion 233, and the fore-end portion 231, in the upstream side of the airflow is larger than 90° and less than 180°.

Turning back to FIG. 1, each of the rack and pinion mechanisms 4a is a mechanism to slide the sliding door 20. The rack and pinion mechanism 4a include a pinion 4b which is rotatably driven by transfer of power from a motor (not shown), and a rack 4c (see FIGS. 2A and 2B) which converts rotational power of the pinion into linear power and transfers the linear power to the sliding door 20. Furthermore, the rack 4c of the rack and pinion mechanism 4a is integrally formed with the sliding door 20.

The heater core 6 is disposed within the heating passage 2b and is to generate the warm air by heating the cold air supplied through the heating opening 3b.

The mode switching damper 7 is a damper to perform the opening and closing of the defroster outlet 2d and the opening and closing of the face outlet 2e, and is rotatably constituted within the case 2.

The foot outlet mode damper 8 is a damper to perform the opening and closing of the foot outlet 2f, and is rotatably constituted within the case 2.

Furthermore, the air mix damper device 4, the mode switching damper 7, and the foot outlet mode damper 8 are supplied with power from the motor (not shown).

In the air conditioning apparatus for a vehicle 1 having such a configuration, when both of the cold air opening 3a and the heating opening 3b are opened by the air mix damper device 4, the air supplied to the cooling passage 2a is cooled by the evaporator 5 to become the cold air and a portion of the cold air is supplied to the heating passage 2b.

The warm air, which is generated by heating of the heater core 6 in the heating passage 2b, is supplied from the warm air opening 2g to the mixing portion 2c, and the other cold air which is not supplied to the heating passage 2b is supplied from the cold air opening 3a to the mixing portion 2c.

The cold air and warm air, which are supplied to the mixing portion 2c, are mixed to become the conditioned air, and the conditioned air is supplied into the vehicle interior from any one of the defroster outlet 2d, the face outlet 2e, and the foot outlet 2f, which is opened.

In the air conditioning apparatus for a vehicle 1 of the above embodiment, the seal member 23 is bent by receiving the airflow, thereby coming into contact with the seal surface 3x (the upper side seal surface 3c, the lower side seal surface 3d, and the intermediate seal surface 3e) which is a portion of the wall surface formed with the cold air opening 3a and the heating opening 3b of the frame 3. When the sliding door 20 completely closes the cold air opening 3a or the heating opening 3b, the seal member 23 comes into contact with the seal surface 3x, thereby preventing a gap from being generated between the sliding door 20 and the frame 3.

In accordance with the air conditioning apparatus for a vehicle 1 of the above embodiment, the gap may be easily prevented from being generated between the sliding door 20 and the frame 3 without providing full-depth teeth on the pinion 4b to slide the sliding door 20. Accordingly, an air leakage may be prevented without causing a complicated structure of the pinion 4b and deterioration in working properties during assembly.

In the air conditioning apparatus for a vehicle 1 of the present embodiment, the seal member 23 has restoration properties. Thus, when the seal member 23 is separated from the seal surface 3x, the seal member 23 is moved in a direction going away therefrom. For this reason, when the sliding door 20 is slid, the seal member 23 is inserted into the cold air opening 3a and the heating opening 3b and may be prevented from being caught between the shield plate 21 and the frame 3.

In the air conditioning apparatus for a vehicle 1 of the present embodiment, the guide rail 3f approaches the upper side seal surface 3c as moving away from the cold air opening 3a, and approaches the lower side seal surface 3d as moving away from the heating opening 3b. Therefore, the seal member 23 of the sliding door 20 smoothly rides onto the seal surface 3x (the upper side seal surface 3c or the lower side seal surface 3d), and the sliding door 20 approaches an upper end thereof or a lower end thereof, thereby enabling the seal member 23 to be further strongly pressed against the seal surface 3x (the upper side seal surface 3c or the lower side seal surface 3d) and enabling sealing properties to be further enhanced.

In addition, in order to strongly press the seal member 23 against the seal surface 3x, the seal member 23 may be inclined with respect to the shield plate 21 in the downstream side of the airflow. Thereby, in a case where the cold air opening 3a is closed or the heating opening 3b is closed, the seal member 23 may be strongly pressed against both of the upper side seal surface 3c and the intermediate seal surface 3e or both of the lower side seal surface 3d and the intermediate seal surface 3e.

In this case, for example, if a flat sliding door is used, a projected area of the shield plate 21 becomes small when viewed from the flow direction of the airflow. For this reason, the central portion of the sliding door 20 in the sliding direction thereof may be curved so as to swell toward the downstream side of the airflow. Thus, the projected area of the seal member 23 becomes wide when viewed from flow direction of the airflow, and the seal member 23 becomes to be further easily bent. Consequently, it may be possible to improve adhesive properties between the seal member 23 and the seal surface 3x and enhance sealing properties.

In the air conditioning apparatus for a vehicle 1 of the present embodiment, the seal member 23 includes the fore-end portion 231 which has the contact surface with the seal surface 3x, the contact surface being the curved surface, the base portion 232 connected with the shield plate 21, and the neck portion 233 which is connected with the fore-end portion 231 and the base portion 232 and is thinner than the base portion 232. Such a seal member 23 is bent around the neck portion 233 which is easiest to be deformed. Therefore, a deformation amount when being bent is always equal, and stable sealing properties may be obtained.

In addition, the contact surface of the fore-end portion 231 with the seal surface 3x is the curved surface. For this reason, as shown in FIGS. 4A to 4C, even when a positional relationship between the fore-end portion 231 and the seal surface 3x varies according to the movement of the sliding door 20, the fore-end portion 231 may be always in contact with the seal surface 3x and stable sealing properties may be obtained.

In the air conditioning apparatus for a vehicle 1 of the present embodiment, the position of the seal member 23 with respect to the shield plate 21 is set so that the angle θ between the seal surface 3x and the axis L, which penetrates the centers of the base portion 232, the neck portion 233, and the fore-end portion 231, in the upstream side of the airflow is larger than 90° and less than 180°. Therefore, it may be possible to suppress the seal member being caught between the shield plate 21 and the seal surface 3x during the movement of the sliding door 20.

While the preferred embodiment of the invention has been described with reference to the accompanying drawings, the present invention is not limited to only the above embodiment. Various shapes, combinations or the like illustrated in the above-mentioned embodiment serve as an example, and various modifications and variations can be made based on the design requirement and the like without departing from the spirit or scope of the present invention.

In the above embodiment, the configuration has been described in which the seal member 23 is made of an elastic material having restoration properties for example. However, the present invention is not limited thereto, and any member may be used as the seal member as long as being easily bent more than the shield plate. For example, a resin film, which is easily bent by receiving the airflow, may also be used as the seal member.

In the above embodiment, the air conditioning apparatus for a vehicle including one sliding door has been described. However, there is also an air conditioning apparatus for a vehicle in which the inside of a case is divided into the driver seat side and the passenger seat side, and the temperatures of the driver seat side and the passenger seat side are independently regulated in two sliding doors. The air conditioning apparatus for a vehicle of the present invention may also be applied to an air conditioning apparatus for a vehicle including two sliding doors.

What is claimed is:

1. An air conditioning apparatus for a vehicle that includes a frame having an opening through which an airflow passes, and a sliding door which adjusts an aperture ratio of the opening by being slid along a wall surface formed with the opening of the frame in an upstream side of the opening,
wherein the sliding door includes:
a shield plate to shield the airflow; and
a seal member which extends from the shield plate in a sliding direction of the sliding door and is more easily bent than the shield plate, and which is bent by receiving the airflow, thereby coming into contact with the wall surface of the frame.

2. The air conditioning apparatus for a vehicle according to claim 1, wherein the seal member has restoration properties.

3. The air conditioning apparatus for a vehicle according to claim 1, wherein the frame includes:
a seal surface which is disposed adjacent to the opening and comes into contact with the seal member; and
a guide which guides the sliding door and approaches the seal surface as moving away from the opening.

4. The air conditioning apparatus for a vehicle according to claim 1, wherein the seal member is inclined in a downstream side of the airflow.

5. The air conditioning apparatus for a vehicle according to claim 3, wherein the guide is curved so that a central portion of the sliding door in the sliding direction thereof swells toward the downstream side of the airflow.

6. The air conditioning apparatus for a vehicle according to claim 1,
wherein the seal member includes:
a fore-end portion which has a contact surface with the frame, the contact surface being a curved surface;
a base portion connected with the shield plate; and
a neck portion which is connected with the fore-end portion and the base portion and is thinner than the base portion.

7. The air conditioning apparatus for a vehicle according to claim 6, wherein a position of the seal member is set so that an angle between an axis, which penetrates centers of the base portion, the neck portion, and the fore-end portion, and the wall surface of the frame, which comes into contact with the seal member, in the upstream side of the airflow is larger than 90° and less than 180°.
